(19) United States
(12) Patent Application Publication
(10) Pub. No.: US 2016/0115912 A1
(43) Pub. Date: Apr. 28, 2016

(54) VEHICLE

(71) Applicant: TOYOTA JIDOSHA KABUSHIKI KAISHA, Toyota-shi (JP)

(72) Inventors: Jun TAKAGAWA, Toyota-shi (JP); Toshio DOKE, Miyoshi-shi (JP)

(73) Assignee: TOYOTA JIDOSHA KABUSHIKI KAISHA, Toyota-shi (JP)

(21) Appl. No.: 14/840,211

(22) Filed: Aug. 31, 2015

(30) Foreign Application Priority Data
Oct. 24, 2014 (JP) 2014-217586

(51) Int. Cl. F02M 25/08

(52) U.S. Cl. CPC F02M 25/089; F02M 25/0854

(57) ABSTRACT

The vehicle has a fuel vapor releasing device, a brake booster, a negative pressure pump, and a pump suction passage which puts the fuel vapor releasing device, the constant pressure chamber and a suction port of the negative pressure pump in communication. The vehicle also has an air intake passage in communication and a brake negative pressure control valve which switches selectively between communication of the suction port with the constant pressure chamber and disconnection of the communication. When the negative pressure pump is actuated to produce a negative pressure which is supplied to the constant pressure chamber of the brake booster, on condition that a suction pressure of the pump suction passage is equal to or lower than a booster pressure of the constant pressure chamber, the brake negative pressure control valve is opened.

### BACKGROUND OF THE INVENTION

The present invention relates to a control device of a vehicle that is provided with a device for releasing a gas containing a fuel component into an air intake passage of an internal combustion engine by using a negative pressure and an actuator, which is actuated by using the negative pressure.

Japanese Laid-Open Patent Publication No. 2012-107590, discloses a fuel vapor releasing device installed on a vehicle having an internal combustion engine as a driving source. The device releases fuel vapor produced inside a fuel tank into an air intake passage of the internal combustion engine. The fuel vapor releasing device is provided with a canister, which adsorbs and collects fuel vapor, and a purge passage through which the canister is put in communication with the air intake passage. In this device, a negative pressure of intake air, which is a pressure inside the air intake passage, is used to release purge gas, which is a gas containing fuel vapor inside the canister, via a purge passage into the air intake passage.

Japanese Laid-Open Patent Publication No. 2012-107590 discloses a brake booster of a brake device by which the brake is applied to a vehicle. In the vehicle, when a brake pedal is operated by a driver, a negative pressure is supplied into the brake booster to assist operation of the brake pedal.

Japanese Laid-Open Patent Publication No. 2012-107590 discloses a negative pressure pump which is connected to a pressure chamber of a brake booster and to a canister and a selector valve which connects selectively a suction port of the negative pressure pump to one of the pressure chamber of the brake booster and the canister.

When a negative pressure is supplied into the brake booster, the selector valve is operated so that the suction port of the negative pressure pump is connected to the pressure chamber of the brake booster. Thereby, a negative pressure produced by actuation of the negative pressure pump is supplied to the pressure chamber of the brake booster.

On the other hand, when a test for existence of abnormal leakage of purge gas from the fuel vapor releasing device is performed, first, the selector valve is operated so that the suction port of the negative pressure pump is connected to the canister. Then, with the above-described state kept, the negative pressure pump is actuated to lower an internal pressure of the fuel vapor releasing device. Thereafter, actuation of the negative pressure pump is stopped and the internal pressure of the fuel vapor releasing device is monitored. Thereby, a determination is made as to whether abnormal leakage from the fuel vapor releasing device is occurring.

As described so far, in the vehicle disclosed in Japanese Laid-Open Patent Publication No. 2012-107590, the negative pressure produced by the negative pressure pump is selectively supplied to one of the pressure chamber of the brake booster and the canister.

In the above-described vehicle, after a test has been performed for the abnormal leakage from the fuel vapor releasing device, purge gas remains inside a passage from which a gas is drawn into the negative pressure pump. Therefore, when the negative pressure pump is actuated in this state to supply negative pressure to the pressure chamber of the brake booster, there is a possibility that the purge gas remaining inside the passage may enter the pressure chamber of the brake booster. In this case, there is a possibility that a member composed of a resin material or a rubber material may swell unnecessarily as a result of exposure to the fuel component contained in the purge gas. That is, there is a possibility that the fuel component may adversely affect various types of members installed inside the brake booster.

The above-described problem has been commonly found in a vehicle that is provided with a releasing device that uses negative pressure to release a gas containing a fuel component into an air intake passage, an actuator that is actuated by using the negative pressure and a negative pressure pump that supplies the negative pressure to the releasing device and the actuator.

### SUMMARY OF THE INVENTION

In order to solve the above-described problems, according to the first mode of the present invention, a vehicle is provided with a releasing device that uses a negative pressure to release a gas containing a fuel component into an air intake passage of an internal combustion engine, an actuator that is actuated by using the negative pressure introduced into a pressure chamber, a negative pressure pump, which supplies the negative pressure to the releasing device and the pressure chamber, a suction passage, which puts the releasing device, the pressure chamber and a suction port of the negative pressure pump in communication, an ejection passage, which puts an ejection port of the negative pressure pump and the air intake passage in communication, and an actuation selector valve, which selectively switches between communication of the suction port with the pressure chamber and disconnection of the communication. When the negative pressure pump is actuated to produce negative pressure supplied to the pressure chamber and if such a condition is met that the internal pressure of the suction passage is equal to or lower than the internal pressure of the pressure chamber, a control device switches an actuation mode of the actuation selector valve to a mode that puts the pressure chamber and the suction port in communication.

### BRIEF DESCRIPTION OF THE DRAWINGS

FIG. 1 is a schematic configuration diagram which shows a control device of a vehicle according to one embodiment of the present invention.

FIG. 2 is a cross-sectional pattern diagram which shows a brake booster.

FIG. 3 is a flow chart which shows procedures of performing purge treatment.

FIG. 4 is a flow chart which shows procedures of performing negative pressure supply treatment.

FIG. 5 is a schematic configuration diagram which shows a control device of a vehicle in the other embodiment.

### DETAILED DESCRIPTION OF THE PREFERRED EMBODIMENTS

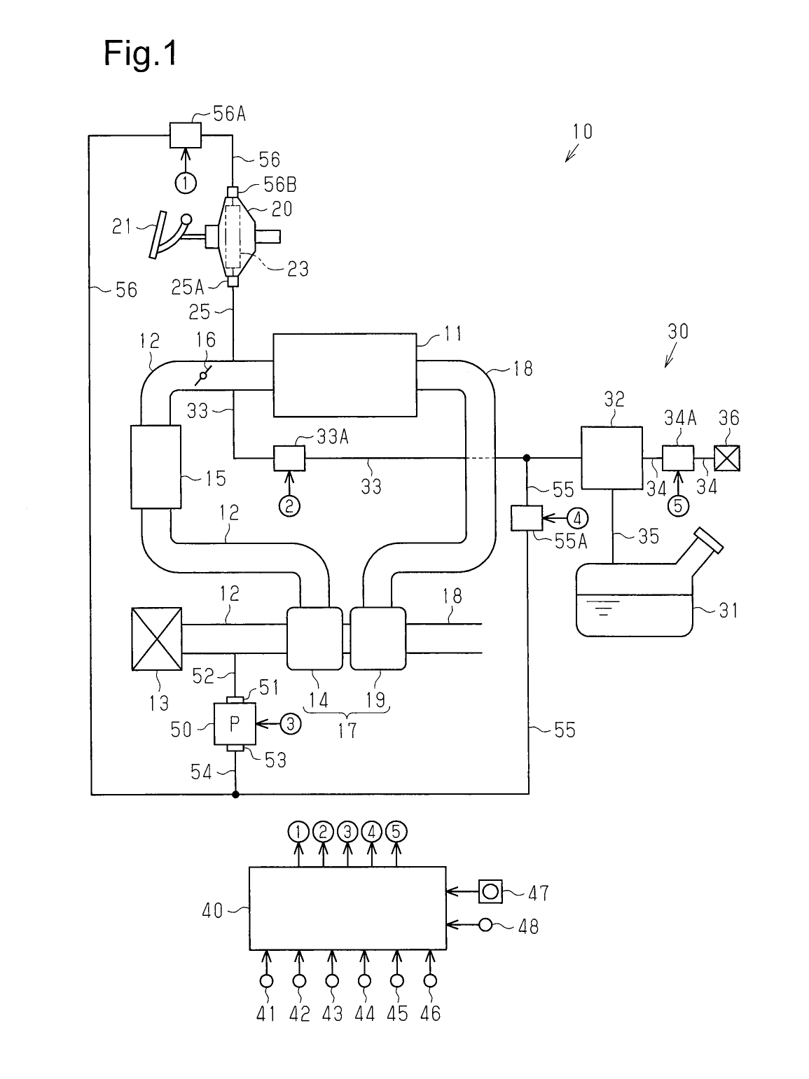

Hereinafter, a description will be given of one embodiment, which specifically embodies a control device of a vehicle in the present invention, with reference to FIG. 1 to FIG. 4.

As shown in FIG. 1, a vehicle 10 is provided with an internal combustion engine 11 as a driving source. An air filter 13, a compressor 14, an intercooler 15 and a throttle valve 16 are installed in that order from an upstream end of an air intake passage 12 of the internal combustion engine 11. The air filter 13 filters air that is drawn into the air intake passage 12. The compressor 14 is a part of an exhaust drive type forced-induction device 17. The forced-induction device 17 is provided with an exhaust turbine 19, which is installed in an exhaust passage 18 of the internal combustion engine 11, in addition to the compressor 14. When a large amount of exhaust air passes through the exhaust turbine 19 during operation of the internal combustion engine 11, intake air that flows through the air intake passage 12 is fed under pressure by the compressor 14 and forcibly delivered into a cylinder of the internal combustion engine 11. The intercooler 15 is a heat exchanger that cools the intake air through heat exchange with outdoor air. The throttle valve 16 adjusts an amount of air introduced into the cylinder of the internal combustion engine 11 via the air intake passage 12.

A brake booster 20 is installed on the vehicle 10. Basically, the brake booster 20 uses a negative pressure of intake air at a portion of the air intake passage 12 that is downstream of the throttle valve 16, thereby boosting and transmitting on the force applied to a brake pedal 21 (operation force).

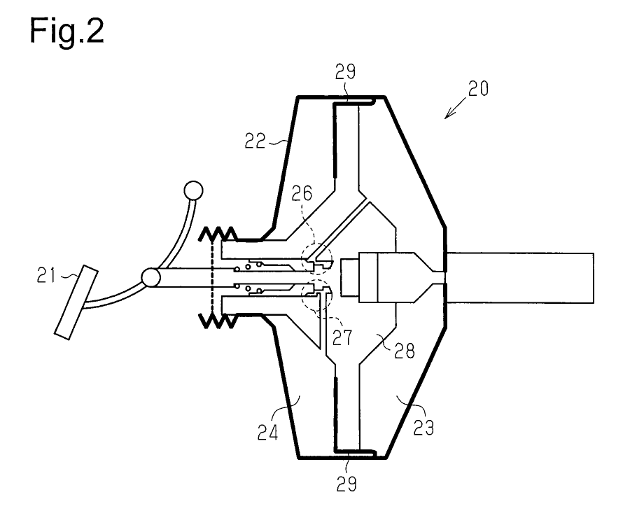

As shown in FIG. 1 and FIG. 2, the interior of a case 22 of the brake booster 20 is divided into two pressure chambers, that is a constant pressure chamber 23 and a pressure changing chamber 24. The constant pressure chamber 23 is put in communication with a portion of the air intake passage 12 at a downstream side from the throttle valve 16 via a first brake passage 25 and a check valve 25A. Therefore, when a pressure of the intake air Pa at a portion of the air intake passage 12 at a downstream side from the throttle valve 16 is lower than a pressure at the constant pressure chamber 23, the check valve 25A is opened to supply a negative pressure (more specifically, a pressure lower than an atmospheric pressure) into the constant pressure chamber 23. On the other hand, when the pressure of the intake air Pa is equal to or higher than the pressure at the constant pressure chamber 23, the check valve 25A is closed and, therefore, no negative pressure is supplied to the constant pressure chamber 23. As described so far, the negative pressure is supplied to the constant pressure chamber 23 of the brake booster 20 by using the negative pressure of the intake air.

Further, two valves, that is, a vacuum valve 26 and a breather valve 27 are installed inside the brake booster 20. When the vacuum valve 26 is opened, the constant pressure chamber 23 is put in communication with the pressure changing chamber 24. When the vacuum valve 26 is closed, communication of the constant pressure chamber 23 with the pressure changing chamber 24 is disconnected. When the breather valve 27 is opened, the pressure changing chamber 24 is exposed to the atmosphere.

Still further, a piston 28 and a diaphragm 29 are arranged inside the brake booster 20. The diaphragm 29 extends between an external face of the piston 28 and an internal face of the case 22. The interior of the brake booster 20 is divided into the constant pressure chamber 23 and the pressure changing chamber 24 by the piston 28 and the diaphragm 29. The piston 28 is coupled to the brake pedal 21. The piston 28 is arranged to move by the operation of the brake pedal 21.

When the brake pedal 21 is not stepped on, the vacuum valve 26 is opened and also the breather valve 27 is closed. At this time, the constant pressure chamber 23 is put in communication with the pressure changing chamber 24, by which a negative pressure of the intake air of the internal combustion engine 11 is supplied to the interiors thereof. Therefore, the constant pressure chamber 23 is substantially equal in pressure to the pressure changing chamber 24.

When the brake pedal 21 is stepped on, the piston 28 moves, by which the vacuum valve 26 is closed and also the breather valve 27 is opened. At this time, communication of the constant pressure chamber 23 with the pressure changing chamber 24 is disconnected and also a pressure inside the pressure changing chamber 24 gradually comes close to an atmospheric pressure. As a result, the pressure of the pressure changing chamber 24 is higher than the pressure of the constant pressure chamber 23. Then, the piston 28 is pressed due to a difference in pressure between the constant pressure chamber 23 and the pressure changing chamber 24, thereby assisting the operation of the brake pedal 21.

As shown in FIG. 1, the vehicle 10 is provided with a fuel vapor releasing device 30, which releases fuel vapor produced inside a fuel tank 31, more particularly, purge gas. That is, gas containing fuel vapor is released into the air intake passage 12 of the internal combustion engine 11. The fuel vapor releasing device 30 is provided with, among other things, a canister 32, which collects fuel vapor produced at the fuel tank 31, a first purge passage 33, which releases the collected fuel vapor into the air intake passage 12 for cleaning (purge), and an atmospheric air passage 34, which introduces atmospheric air into the canister 32 on purge.

Activated carbon is filled inside the canister 32 as an adsorbent for adsorbing fuel vapor. The canister 32 is connected via the first purge passage 33 to a portion of the air intake passage 12 that is downstream side of the throttle valve 16. A first purge control valve 33A for opening and closing the first purge passage 33 is installed on the first purge passage 33.

Further, the canister 32 is connected via a vapor passage 35 to the fuel tank 31. Fuel vapor inside the fuel tank 31 is introduced via the vapor passage 35 into the canister 32.

Still further, the atmospheric air passage 34 is connected to the canister 32. An atmospheric-air releasing valve 34A and a filter 36 are attached on the atmospheric air passage 34. When an operation switch 47 is operated by a driver and turned on to start operation of the vehicle 10, the atmospheric-air releasing valve 34A is opened. When the operation switch 47 is operated and turned off to stop the operation of the vehicle 10, the atmospheric-air releasing valve 34A is closed. Therefore, upon release of purge gas during operation of the vehicle 10, when a pressure inside the canister 32 is lower than an atmospheric pressure, atmospheric air, which has been filtered by the filter 36, is introduced via the atmospheric air passage 34 into the canister 32. On the other hand, when the pressure inside the canister 32 is higher than an atmospheric pressure, air inside the canister 32 is filtered through the filter 36 and, thereafter, discharged into the atmosphere via the atmospheric air passage 34.

Upon production of fuel vapor inside the fuel tank 31, the fuel vapor is introduced into the canister 32 via the vapor passage 35 and temporarily adsorbed on an adsorbent inside the canister 32. On the other hand, when the first purge control valve 33A is opened during operation of the internal combustion engine 11, a negative pressure of the intake air in the air intake passage 12 is supplied to the first purge passage 33. In addition to supplying the negative pressure of the intake air to the first purge passage 33, atmospheric air is introduced via the atmospheric air passage 34 into the canister 32. Thereby, the fuel vapor inside the canister 32 is separated from the adsorbent by the introduced atmospheric air and is released into the air intake passage 12 via the first purge passage 33 and subjected to purge treatment.

As various types of sensors for detecting an operation state of the vehicle 10, the vehicle 10 is provided with a vehicle speed sensor 41 for detecting a traveling speed (vehicle speed SPD) of the vehicle 10, a pressure sensor 42 for detecting an internal pressure (booster pressure Pb) of the constant pressure chamber 23 of the brake booster 20, a pressure sensor 43 for detecting a pressure (pressure of intake air Pa) at a portion of the air intake passage 12 that is downstream of the throttle valve 16 and a speed sensor 44 for detecting a rotation speed (engine rotation speed NE) of an output shaft of the internal combustion engine 11. The vehicle 10 is also provided with an air flow meter 45 for detecting the amount of air introduced into a cylinder of the internal combustion engine 11 (intake air flow rate GA), an oxygen concentration sensor 46 for detecting an oxygen concentration of exhaust air OX as an index value of air fuel ratio, an operation switch 47, etc.

An electronic control unit 40 for controlling the operation of the vehicle 10 is installed on the vehicle 10. Output signals of various types of sensors are incorporated into the electronic control unit 40. The electronic control unit 40 performs various types of computations based on signals detected by various types of sensors and also performs various types of controls for operating the vehicle such as actuation control of the throttle valve 16 and actuation control of the first purge control valve 33A based on computation results thereof.

When forced induction is performed by using the forced-induction device 17, the pressure of intake air Pa in the air intake passage 12 is increased. Thus, it is impossible to use the negative pressure of intake air in the air intake passage 12 for supplying the negative pressure to the brake booster 20 and the fuel vapor releasing device 30. Therefore, the vehicle 10 is provided with an electric motor-driven type negative pressure pump 50 for producing negative pressure. The negative pressure produced by the negative pressure pump 50 is supplied to the constant pressure chamber 23 of the brake booster 20 and the canister 32 of the fuel vapor releasing device 30. Actuation of the negative pressure pump 50 is controlled by the electronic control unit 40.

Hereinafter, the negative pressure pump 50 and a peripheral structure thereof will be described in detail with reference to FIG. 1.

As shown in FIG. 1, an ejection port 51 of the negative pressure pump 50 is connected to a pump ejection passage 52. The pump ejection passage 52 is connected to a portion of the air intake passage 12 at an upstream side of the compressor 14, more specifically, at a portion of the air intake passage 12 between the compressor 14 and the air filter 13. A pump suction passage 54 is connected to a suction port 53 of the negative pressure pump 50. The pump suction passage 54 is connected via a second purge passage 55 to the canister 32. Further, the pump suction passage 54 is connected via a second brake passage 56 to the constant pressure chamber 23 of the brake booster 20. The vehicle 10 is provided with a pressure sensor 48 for detecting an internal pressure (suction pressure Pv) in the pump suction passage 54, which is constantly in communication with the suction port 53 of the negative pressure pump 50. In the present embodiment, the pump suction passage 54, the second purge passage 55 and the second brake passage 56 are respectively equivalent to the canister 32 of the fuel vapor releasing device 30, the constant pressure chamber 23 of the brake booster 20 and the suction passage that puts the suction port 53 of the negative pressure pump 50 in communication.

The second purge passage 55 is provided with a second purge control valve 55A for opening and closing the second purge passage 55. When the second purge control valve 55A is opened, the pump suction passage 54 is put in communication with the canister 32 via the second purge passage 55. When the second purge control valve 55A is closed, communication of the pump suction passage 54 with the canister 32 via the second purge passage 55 is disconnected. The second purge control valve 55A is equivalent to a gas selector valve.

Further, the second brake passage 56 is provided with a brake negative pressure control valve 56A for opening and closing the second brake passage 56 and a check valve 56B. When the brake negative pressure control valve 56A and the check valve 56B are opened, the pump suction passage 54 is put in communication with the constant pressure chamber 23 via the second brake passage 56. When the brake negative pressure control valve 56A and the check valve 56B are closed, communication of the pump suction passage 54 with the constant pressure chamber 23 via the second brake passage 56 is disconnected. When an internal pressure of the second purge passage 55 is lower than an internal pressure of the constant pressure chamber 23 of the brake booster 20, the check valve 56B is opened. When the internal pressure of the second purge passage 55 is equal to or higher than the internal pressure of the constant pressure chamber 23 of the brake booster 20, the check valve 56B is closed. The brake negative pressure control valve 56A is equivalent to an actuation selector valve.

When a negative pressure produced by the negative pressure pump 50 is used to release purge gas into the air intake passage 12, the second purge control valve 55A is opened and the negative pressure pump 50 is also actuated. Thereby, the negative pressure produced by the negative pressure pump 50 is supplied into the canister 32 via the pump suction passage 54 and the second purge passage 55. Accordingly, atmospheric air is introduced via the atmospheric air passage 34 into the canister 32. Then, fuel vapor inside the canister 32 is separated from an adsorbent by the introduced atmospheric air, also released via the second purge passage 55 into the air intake passage 12 and subjected to purge treatment.

Further, when the negative pressure produced by the negative pressure pump 50 is supplied to the constant pressure chamber 23 of the brake booster 20, the brake negative pressure control valve 56A is opened and the negative pressure pump 50 is also actuated. Thereby, negative pressure produced by the negative pressure pump 50 is supplied via the pump suction passage 54 and the second brake passage 56 to the constant pressure chamber 23 of the brake booster 20.

In the above-described arrangement, after the negative pressure produced by the negative pressure pump 50 is used to release purge gas, the purge gas remains inside the pump suction passage 54 and the second purge passage 55. Further, the pump suction passage 54 and the second purge passage 55 are put in communication with the second brake passage 56. Therefore, when the brake negative pressure control valve 56A is opened to supply the negative pressure produced by the negative pressure pump 50 to the constant pressure chamber 23 of the brake booster 20, there is a possibility that the purge gas remaining inside the pump suction passage 54 and the second purge passage 55 may enter the constant pressure chamber 23 via the second brake passage 56.

In this case, there is a possibility that a member composed of a resin material and a rubber material, more specifically, the diaphragm 29 and various types of seal members, etc., shown in FIG. 2 may be caused to swell unnecessarily by a fuel component contained in the purge gas. That is, there is a possibility that the fuel component may adversely affect various types of members installed inside the brake booster 20. More specifically, there is a possibility that the durability and functions of the diaphragm 29 and seal members may deteriorate. Further, such swelling of various types of members may allow the position of the piston 28 when no operation force is being applied to the brake pedal 21 to deviate in a direction in which the piston 28 moves when the brake pedal 21 is stepped on. In this case, the brake device is unnecessarily kept actuated and sliding members such as a brake pad and a brake disk may experience undue wear.

Therefore, in the vehicle 10, when the negative pressure pump 50 is actuated to supply the negative pressure to the constant pressure chamber 23 of the brake booster 20, on such a condition that the suction pressure Pv, which is the internal pressure of the pump suction passage 54, is equal to or lower than the booster pressure Pb, which is the internal pressure of the constant pressure chamber 23, the brake negative pressure control valve 56A is controlled to be opened.

When the suction pressure Pv of the pump suction passage 54 is higher than the booster pressure Pb of the constant pressure chamber 23, due to a difference between the suction pressure Pv and the booster pressure Pb, a gas inside the second brake passage 56 is pushed away into the constant pressure chamber 23 of the brake booster 20. Therefore, when the brake negative pressure control valve 56A is opened, there is a possibility that the gas inside the second brake passage 56 may flow into the constant pressure chamber 23 of the brake booster 20. In this respect, according to the present embodiment, since the brake negative pressure control valve 56A is kept closed and held as it is in the above case, it is possible to prevent purge gas from permeating into the constant pressure chamber 23.

On the other hand, when the suction pressure Pv is equal to or lower than the booster pressure Pb, due to a difference between the suction pressure Pv and the booster pressure Pb, a gas inside the second brake passage 56 is suctioned into the suction port 53 of the negative pressure pump 50. Therefore, when the brake negative pressure control valve 56A is opened, it is much less likely that the gas inside the second brake passage 56 flows into the constant pressure chamber 23 of the brake booster 20. As a result, according to the present embodiment, only when the suction pressure Pv is equal to or lower than the booster pressure Pb, the brake negative pressure control valve 56A is opened to put the suction port 53 of the negative pressure pump 50 and the constant pressure chamber 23 in communication, and the negative pressure produced by the negative pressure pump 50 is supplied to the constant pressure chamber 23.

Accordingly, although the negative pressure produced by the negative pressure pump 50 is supplied via the pump suction passage 54 and the second brake passage 56 into which purge gas containing a fuel component gets mixed in the constant pressure chamber 23 of the brake booster 20, it is possible to prevent the fuel component from permeating into the constant pressure chamber 23.

Further, when the negative pump 50 is actuated to supply the negative pressure to the constant pressure chamber 23 of the brake booster 20 and if the suction pressure Pv is higher than the booster pressure Pb, until the suction pressure Pv becomes equal to or lower than the booster pressure Pb, the negative pressure pump 50 is actuated, with both of the brake negative pressure control valve 56A and the second purge control valve 55A being closed.

At this time, communication of the constant pressure chamber 23 of the brake booster 20 with the pump suction passage 54 is disconnected and also the negative pressure pump 50 is actuated in a state in which communication of the canister 32 with the pump suction passage 54 is disconnected. Therefore, it is possible to quickly lower the suction pressure Pv, which is the internal pressure of the pump suction passage 54. As a result, when the suction pressure Pv is higher than the booster pressure Pb, the suction pressure Pv can be quickly lowered to a pressure equal to or lower than the booster pressure Pb. Thereby, it is possible to quickly start introduction of the negative pressure into the constant pressure chamber 23 of the brake booster 20. At this time, it is also possible to release purge gas that remains in the pump suction passage 54, the second purge passage 55 and the second brake passage 56 into the air intake passage 12.

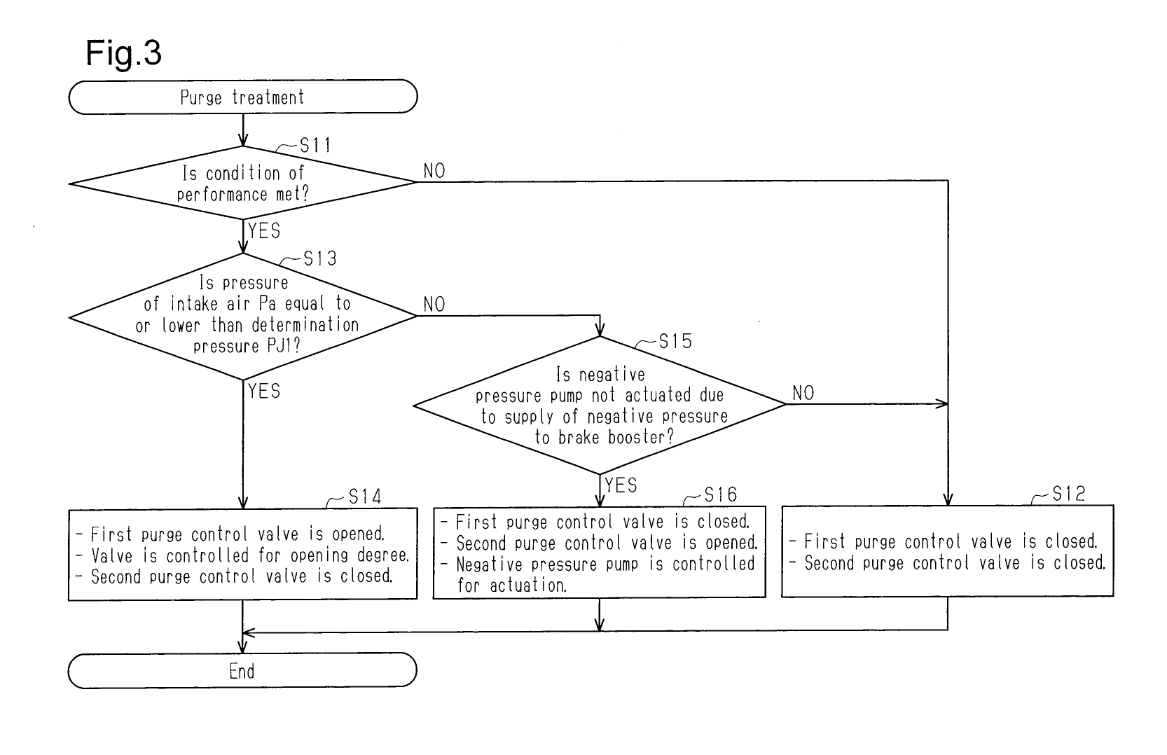

Hereinafter, purge treatment, by which purge gas is released by the fuel vapor releasing device 30, will be described in detail with reference to FIG. 3.

A series of treatments shown in FIG. 3 is performed by the electronic control unit 40 as interruption treatments at every predetermined cycle.

As shown in FIG. 3, first, a judgment is made as to whether or not a condition for performing purge treatment is met (Step S11). In this case, when conditions that the internal combustion engine 11 has completed warming-up, the internal combustion engine 11 is not operated at a high load region and the internal combustion engine 11 is in a steady operation state in which the operation state thereof undergoes a small change are met, it is judged that the condition of performing purge treatment is met.

When the above-described conditions are not met (Step S11: NO), both of the first purge control valve 33A and the second purge control valve 55A are closed (Step S12). In this case, neither supply of the negative pressure produced by the negative pressure pump 50 to the canister 32 nor supply of the negative pressure of intake air to the canister 32 is performed.

Thereafter, when this treatment is performed repeatedly to meet the above-described conditions (Step S11: YES), a judgment is made as to whether or not the pressure of intake air Pa in the air intake passage 12 is equal to or lower than a determination pressure PJ1 (Step S13). Based on the results of various experiments and simulations, there is set, as the determination pressure PJ1, an upper limit of the pressure of intake air Pa, which has been determined in advance as a pressure value capable of releasing an adequate amount of purge gas into the air intake passage 12 by using the negative pressure of intake air.

When the pressure of intake air Pa is equal to or lower than the determination pressure PJ1 (Step S13: YES), a determination is made that an adequate amount of purge gas can be released by using the negative pressure of intake air. The first purge control valve 33A is opened and also the second purge control valve 55A is closed (Step S14). Thereby, the purge gas is released into the air intake passage 12 by using the negative pressure of the intake air. At this time, the amount of released purge gas (purge amount) is adjusted by controlling the opening degree of the first purge control valve 33A. The opening degree of the first purge control valve 33A is adjusted to give an opening degree capable of discharging an adequate amount of purge gas into the air intake passage 12, while variation in the air fuel ratio due to release of the purge gas into the air intake passage 12 is suppressed based on an intake air flow rate GA, the engine rotation speed NE, the oxygen concentration of exhaust air OX and the pressure of the intake air Pa.

On the other hand, when the pressure of the intake air Pa is higher than the determination pressure PJ1 (Step S13: NO), a determination is made that release of purge gas by using the negative pressure of intake air will not obtain a sufficient amount of purge. On condition that the negative pressure pump 50 is not actuated for supplying a negative pressure to the brake booster 20 (Step S15: YES), actuation of the negative pressure pump 50 is started for releasing the purge gas. In more detail, the first purge control valve 33A is closed, the second purge control valve 55A is opened, and actuation of the negative pressure pump 50 is controlled (Step S16). Thereby, the negative pressure produced by the negative pressure pump 50 is supplied into the canister 32 to release the purge gas into the air intake passage 12 by using the negative pressure. More specifically, the negative pressure produced by the negative pressure pump 50 is supplied to the canister 32, by which atmospheric air is introduced via the atmospheric air passage 34 into the canister 32. Thereby, fuel vapor inside the canister 32 is separated from an adsorbent by the introduced atmospheric air, released via the second purge passage 55 into the air intake passage 12 and subjected to purge treatment. At this time, the amount of purge is adjusted by controlling actuation of the negative pressure pump 50. The negative pressure pump 50 is adjusted to give an amount of actuation that is able to discharge an adequate amount of purge gas into the air intake passage 12, while variation in air fuel ratio due to release of the purge gas into the air intake passage 12 is suppressed based on the intake air flow rate GA, the engine rotation speed NE, the oxygen concentration of exhaust air OX and the pressure of intake air Pa.

When the negative pressure pump 50 is actuated for supplying the negative pressure into the brake booster 20 (Step S15: NO), both of the first purge control valve 33A and the second purge control valve 55A are closed (Step S12). In this case, although the pressure of the intake air Pa is higher than the determination pressure PJ1, no negative pressure produced in the negative pressure pump 50 is supplied to the canister 32.

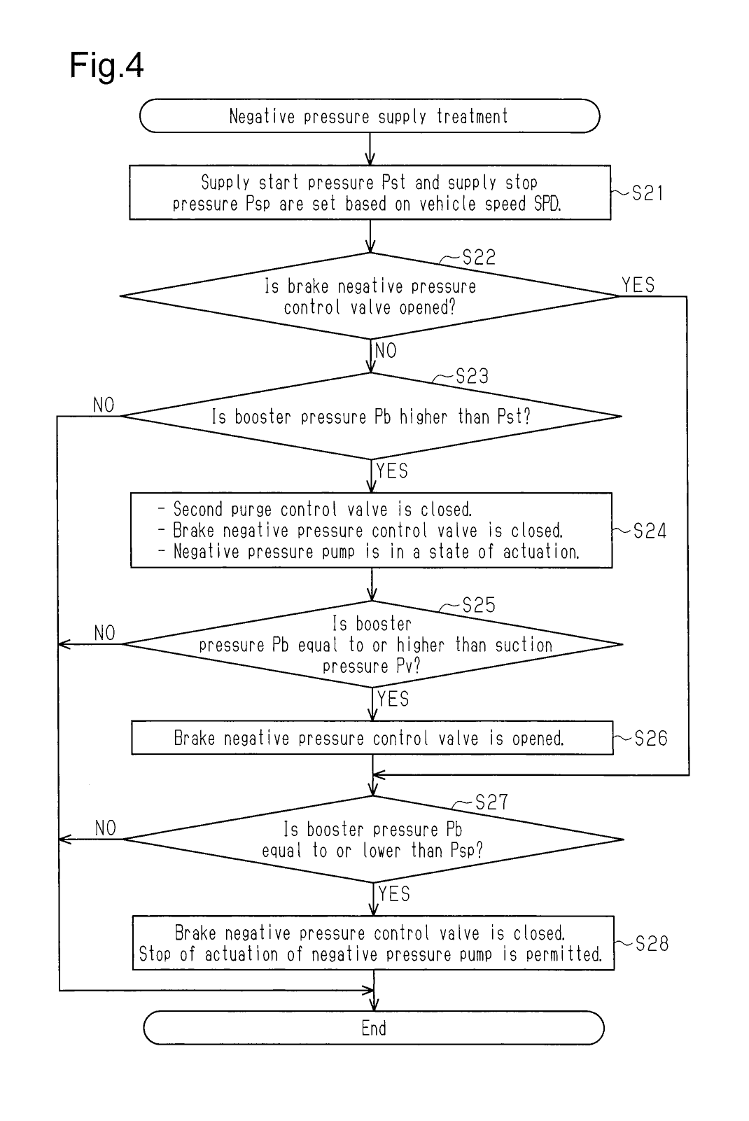

Next, negative pressure supplying treatment for supplying the negative pressure into the brake booster 20 will be described in detail with reference to FIG. 4.

A series of treatments shown in FIG. 4 is performed by the electronic control unit 40 as interruption treatments at every predetermined cycle.

As shown in FIG. 4, first, a supply start pressure Pst and a supply stop pressure Psp are set based on a vehicle speed SPD (Step S21). In the present embodiment, a relationship between the vehicle speed SPD and the booster pressure Pb which obtains an appropriate assistance force is determined based on results of various experiments and simulations. Further, in the relationship between the vehicle speed SPD and the booster pressure Pb, an upper limit of the booster pressure Pb is set as the supply start pressure Pst, and a pressure slightly lower than the supply start pressure Pst is set as the supply stop pressure Psp. In more detail, the relationship between the vehicle speed SPD and the supply start pressure Pst and the relationship between the vehicle speed SPD and the supply stop pressure Psp are stored in advance at the electronic control unit 40, and the supply start pressure Pst and the supply stop pressure Psp are set based on these relationships. More specifically, the higher the vehicle speed SPD is, the lower the supply start pressure Pst or the supply stop pressure Psp is set.

Then, when the brake negative pressure control valve 56A is not opened (Step S22: NO) and the booster pressure Pb is equal to or lower than the supply start pressure Pst (Step S23: NO), the following treatment (treatment in Step S24 to S28) is not performed. In this case, the treatment, which supplies the negative pressure produced by the negative pressure pump 50 into the constant pressure chamber 23 of the brake booster 20, is not performed.

Thereafter, when this treatment is repeatedly performed to make the booster pressure Pb higher than the supply start pressure Pst (Step S23: YES) in a state in which the brake negative pressure control valve 56A is not opened (Step S22: NO), both of the second purge control valve 55A and the brake negative pressure control valve 56A are closed and the negative pressure pump 50 is actuated (Step S24). Then, when the suction pressure Pv is higher than the booster pressure Pb (Step S25: NO), this treatment is temporarily terminated. In this case, a state in which both of the second purge control valve 55A and the brake negative pressure control valve 56A are closed and a state in which the negative pressure pump 50 is actuated are maintained.

On the other hand, when a determination is made by the treatment of Step S25 that the suction pressure Pv is equal to or lower than the booster pressure Pb (Step S25: YES), in a state in which the second purge control valve 55A is closed, the brake negative pressure control valve 56A is opened (Step S26). Thus, the negative pressure produced by the negative pressure pump 50 is supplied via the second brake passage 56 into the constant pressure chamber 23 of the brake booster 20.

In a subsequent period of time during which the booster pressure Pb is higher than the supply stop pressure Psp (Step S27: NO), the treatment of Step S28 is skipped. In this period of time, a state in which the brake negative pressure control value 56A is opened and a state in which the negative pressure pump 50 is actuated are maintained, and the negative pressure is continuously supplied into the constant pressure chamber 23 of the brake booster 20.

Thereafter, when the booster pressure Pb is equal to or lower than the supply stop pressure Psp (Step S27: YES), the brake negative pressure control valve 56A is closed and termination of actuation of the negative pressure pump 50 is permitted (Step S28). Thereby, the supply of the negative pressure produced by the negative pressure pump 50 into the constant pressure chamber 23 of the brake booster 20 is stopped. At this time, on condition that there has been no request for actuating the negative pressure pump 50 for the release of purge gas, actuation of the negative pressure pump 50 is stopped.

According to the present embodiment, the following effects are obtained.

(1) When the negative pressure pump 50 is actuated to supply negative pressure to the constant pressure chamber 23 of the brake booster 20 and if a condition in which the suction pressure Pv is equal to or lower than the booster pressure Pb is met, the brake negative pressure control valve 56A is controlled to be opened. Therefore, although the negative pressure is supplied to the constant pressure chamber 23 of the brake booster 20 via the pump suction passage 54 and the second brake passage 56 into which purge gas containing a fuel component gets mixed, it is possible to prevent the fuel component from entering the constant pressure chamber 23.

(2) When the negative pressure pump 50 is actuated to supply negative pressure to the constant pressure chamber 23 of the brake booster 20 and when the suction pressure Pv is higher than the booster pressure Pb, until the suction pressure Pv becomes equal to or lower than the boost pressure Pb, the negative pressure pump 50 is actuated in a state in which both of the brake negative pressure control valve 56A and the second purge control valve 55A are closed. Therefore, when the suction pressure Pv is higher than the booster pressure Pb, it is possible to quickly lower the suction pressure Pv to a pressure equal to or lower than the booster pressure Pb. It is, thereby, possible to quickly start introduction of the negative pressure into the constant pressure chamber 23 of the brake booster 20.

(3) When the negative pressure produced by the negative pressure pump 50 is supplied to the constant pressure chamber 23 of the brake booster 20, over a period of time from when the suction pressure Pv is equal to or lower than the booster pressure Pb to when the booster pressure Pb is equal to or lower than the supply stop pressure Psp, which is a target pressure, the brake negative pressure control valve 56A is kept open. Therefore, it is possible to prevent gas inside the pump suction passage 54, the second purge passage 55 and the second brake passage 56 from entering the constant pressure chamber 23 of the brake booster 20. It is also possible to lower the internal pressure of the constant pressure chamber 23 to a target pressure and actuate the brake booster 20 appropriately.

(4) If the ejection port 51 of the negative pressure pump 50 is connected to a portion of the air intake passage 12 that is downstream of the throttle valve 16, gas ejected from the negative pressure pump 50 is introduced downstream of the throttle valve 16, which adjusts the intake air flow rate. Therefore, the accuracy of the intake air flow rate may be easily decreased. In the present embodiment, with this point taken into account, the ejection port 51 of the negative pressure pump 50 is connected to a portion of the air intake passage 12 that is upstream of the throttle valve 16. Therefore, gas ejected from the negative pressure pump 50 is introduced into the air intake passage 12 upstream of the location at which the intake air flow rate is adjusted. Thus, it is possible to prevent the accuracy of adjusting the intake air flow rate from being decreased due to introduction of the gas into the air intake passage 12. Accordingly, it is possible to introduce the gas from the negative pressure pump 50 to the air intake passage 12 without unnecessarily altering the intake air flow rate.

(5) The air intake passage 12 is provided with a compressor 14. Therefore, while a portion of the air intake passage 12 downstream from the compressor 14 greatly varies in pressure depending on an operation state of the internal combustion engine 11, a portion thereof at an upstream side of the compressor 14 hardly varies in pressure. In the vehicle 10, the ejection port 51 of the negative pressure pump 50 is connected to the portion of the air intake passage 12 at the upstream side of the compressor 14. In this case, the ejection port 51 of the negative pressure pump 50 is connected to a portion of the air intake passage 12 at which the pressure varies to a small extent. It is, thus, possible to actuate the negative pressure pump 50 efficiently in a stable state. As a result, an amount of purge can be accurately adjusted by controlling actuation of the negative pressure pump 50.

(6) The negative pressure pump 50 can be switched during operation of the internal combustion engine 11 between a state in actuation and a state out of actuation. Therefore, when a negative pressure of intake air of the air intake passage 12 can be used to supply the negative pressure to the constant pressure chamber 23 of the brake booster 20 or supply the negative pressure into the canister 32, that is, when the negative pressure pump 50 is not required for actuation, the negative pressure pump 50 can be stopped for actuation. It is, thereby, possible to effectively reduce of the load on the negative pressure pump 50.

The above-described embodiment may be modified as follows.

The first purge passage 33 and the first purge control valve 33A may be omitted or the first brake passage 25 and the check valve 25A may be omitted.

The brake booster 20 may be changed in structure in any manner, as long as it is structured to be actuated by supply of a negative pressure to the pressure chamber.

There may not be necessarily performed selectively one of release of purge gas by using a negative pressure of intake air and release of purge gas by using a negative pressure of the negative pressure pump 50. There may be, however, set a period of time during which both of them are performed at the same time.

The pump ejection passage 52 may be connected to a portion of the air intake passage 12 at a downstream side of the compressor 14. The pump ejection passage 52 may also be connected to a portion of the air intake passage 12 at the downstream side of the throttle valve 16.

The negative pressure pump 50 may adopt a pump with any given structure such as an engine-driven type pump which is driven by an output shaft of the internal combustion engine 11. When the engine-driven type negative pressure pump is adopted, it is desirable to install a clutch mechanism that connects an output shaft of the engine with an input shaft of the pump and disconnects the connection thereof. In a vehicle with the above-described mechanism, when the negative pressure pump is not required for actuation, the clutch mechanism is switched to a state in which no power is transmitted, thus making it possible to reduce loads of the negative pressure pump. Further, when there is adopted a negative pressure pump which is structurally unable to adjust the production of negative pressure freely, it is desirable to adopt a control valve which is able to adjust an opening degree freely as the second purge control valve 55A. In a vehicle having the above-described structure, an adequate amount of purge gas can be discharged into the air intake passage 12, while variation in air fuel ratio due to release of the purge gas into the air intake passage 12 is suppressed by controlling an opening degree of the second purge control valve 55A based on an operation state of the internal combustion engine 11.

In place of the pressure sensor 48, a pressure sensor for detecting an internal pressure may be installed at a portion of the second purge passage 55 between the second purge control valve 55A and the pump suction passage 54 or a pressure sensor for detecting an internal pressure may be installed at a portion of the second brake passage 56 between the brake negative pressure control valve 56A and the pump suction passage 54. In brief, there may be installed a pressure sensor for detecting the internal pressure at a portion which is constantly put in communication with the suction port 53 of the negative pressure pump 50.

In the negative pressure supply treatment of Step S25 shown in FIG. 4, a judgment may be made for whether or not the suction pressure Pv is lower than the booster pressure Pb.

An actuator which is actuated by using a negative pressure supplied to the pressure chamber may be any type of actuator including the brake booster 20.

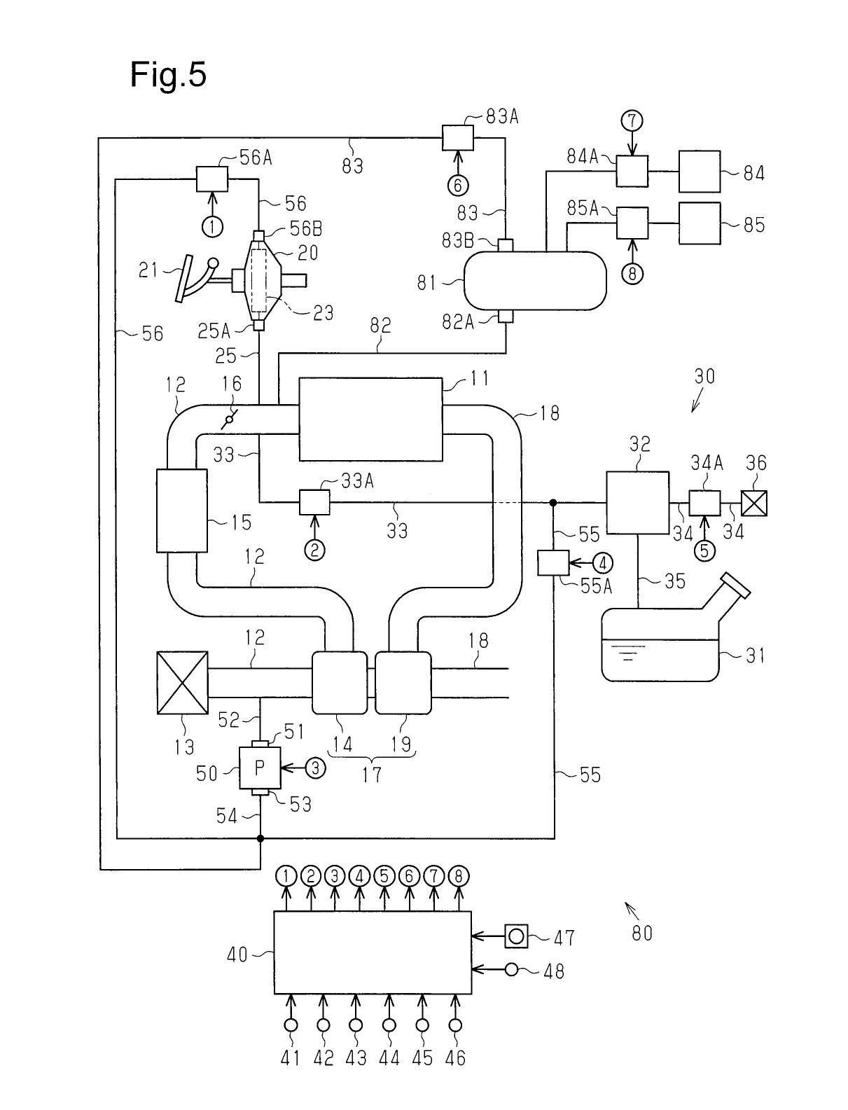

FIG. 5 shows one example of a vehicle on which the above-described actuator is installed. As shown in FIG. 5, a vehicle 80 is provided with a negative pressure tank 81, a second tank introduction passage 83 which puts a pump suction passage 54 and a negative pressure tank 81 in communication, a tank negative pressure control valve 83A which opens and closes the second tank introduction passage 83, and a check valve 83B. When the tank negative pressure control valve 83A and the check valve 83B are opened, a suction port 53 of a negative pressure pump 50 is put in communication with the negative pressure tank 81 via the second tank introduction passage 83. When the tank negative pressure control valve 83A and the check valve 83B are closed, communication of the suction port 53 of the negative pressure pump 50 with the negative pressure tank 81 via the second tank introduction passage 83 is disconnected. When the negative pressure pump 50 is actuated in a state in which the tank negative pressure control valve 83A is opened, the check valve 83B is opened by a negative pressure produced by the negative pressure pump 50, and the negative pressure produced by the negative pressure pump 50 is supplied to the negative pressure tank 81 via the pump suction passage 54 and the second tank introduction passage 83.

Further, a waste gate valve 84 which is actuated by supply of the negative pressure to a pressure chamber is coupled to a negative pressure tank 81 via a first negative pressure control valve 84A. Still further, an engine mount 85 which is able to change vibration control characteristics by supplying or discharging the negative pressure to the pressure chamber is connected to the negative pressure tank 81 via a second negative pressure control valve 85A. In the example shown in FIG. 5, the brake booster 20, the waste gate valve 84 and the engine mount 85 are equivalent to the actuator.

When the negative pressure pump 50 is actuated to produce a negative pressure which is supplied to the pressure chamber of the waste gate valve 84 and if an internal pressure of the negative pressure tank 81 is equal to or lower than an internal pressure of the pressure chamber of the waste gate valve 84, the first negative pressure control valve 84A may be controlled to be opened. In this case, the negative pressure tank 81 constitutes a portion of the suction passage, and the first negative pressure control valve 84A is equivalent to an actuation selector valve.

Further, when the negative pressure pump 50 is actuated to produce a negative pressure which is supplied to a pressure chamber of the engine mount 85 and if an internal pressure of the negative pressure tank 81 is equal to or lower than an internal pressure of the pressure chamber of the engine mount 85, the second negative pressure control valve 85A may be controlled to be opened. In this case as well, the negative pressure tank 81 constitutes a portion of the suction passage, and the second negative pressure control valve 85A is equivalent to an actuation selector valve.

According to the above-described arrangements, although the negative pressure is supplied to the pressure chamber of the actuator via the pump suction passage 54, etc., into which purge gas containing a fuel component gets mixed, it is possible to prevent the fuel component from permeating into the pressure chamber.

The above-described control device may be applied not only to a vehicle on which a fuel vapor releasing device is installed but also to any vehicle having a releasing device in which a negative pressure is used to release a gas containing a fuel component into an air intake passage of an internal combustion engine such as a vehicle having a blow-by gas releasing device in which a blow-by gas inside the internal combustion engine is released into an air intake passage of the internal combustion engine. The blow-by gas releasing device may adopt a device which is provided with a gas discharge passage that puts the pump suction passage 54 connected to the suction port 53 of the negative pressure pump 50 and the interior of the internal combustion engine (for example, the interior of a crankcase) in communication and a PCV control valve that is installed on the gas discharge passage to open and close the gas discharge passage. According to the above-described vehicle, although a negative pressure is supplied to the constant pressure chamber 23 of the brake booster 20 via a passage into which a blow-by gas containing a fuel component gets mixed (the pump suction passage 54, etc.), it is possible to prevent the fuel component from permeating into the constant pressure chamber 23.

The above-described control device may be applied to a vehicle which is provided with an engine-driven type forced-induction device in which a compressor is driven by an output shaft of the internal combustion engine 11 and also to a vehicle which is free of a forced-induction device or the intercooler 15.

1. A vehicle comprising
a releasing device which releases a gas containing a fuel component into an air intake passage of an internal combustion engine by using a negative pressure,
an actuator which is actuated by using a negative pressure introduced into a pressure chamber,
a negative pressure pump which supplies a negative pressure to the releasing device and the pressure chamber,
a suction passage which puts the releasing device, the pressure chamber and a suction port of the negative pressure pump in communication,
an ejection passage which puts an ejection port of the negative pressure pump and the air intake passage in communication,
an actuation selector valve which selectively switches between communication of the suction port with the pressure chamber and disconnection of the communication, and
a control device, wherein
when the negative pressure pump is actuated to produce a negative pressure which is supplied to the pressure chamber, the control device switches a mode of actuating the actuation selector valve to a mode of putting the pressure chamber and the suction port in communication if such a condition that an internal pressure of the suction passage is equal to or lower than an internal pressure of the pressure chamber is met.

2. The vehicle according to claim 1, wherein
the control device is provided with a gas selector valve which switches between communication of the releasing device with the suction port and disconnection of the communication, when the negative pressure pump is actuated to produce a negative pressure which is supplied to the pressure chamber, until an internal pressure of the suction passage is equal to or lower than an internal pressure of the pressure chamber, the negative pressure pump is actuated in a state in which the actuation selector valve and the gas selector value are closed.

3. The vehicle according to claim 1, wherein
the control device keeps a mode of actuating the actuation selector valve in a mode which puts the pressure chamber and the suction port in communication over a period of time from when the internal pressure of the suction passage is equal to or lower than the internal pressure of the pressure chamber to when the internal pressure of the pressure chamber is equal to or lower than a target pressure.

4. The vehicle according to claim 1, wherein
the ejection passage is connected to a portion of the air intake passage at an upstream side of a throttle valve.

5. The vehicle according to claim 1, wherein
a compressor which feeds intake air under pressure is installed on the air intake passage, and
the ejection passage is connected to a portion of the air intake passage at an upstream side of the compressor.

6. The vehicle according to claim 1, wherein
the negative pressure pump is a pump which is capable of switching during operation of the internal combustion engine between a state in actuation and a state out of actuation.
